(19) United States
(12) Patent Application Publication
(10) Pub. No.: US 2012/0067257 A1
(43) Pub. Date: Mar. 22, 2012

(54) A Lateral Transfer System

(75) Inventors: Marc Bacon, Stittsville (CA); Andreas Tsangaris, Ottawa (CA)

(73) Assignee: Plasco Energy Group. Inc., Kanata (CA)

(21) Appl. No.: 13/263,330

(22) PCT Filed: Mar. 1, 2011
(86) PCT No.: PCT/CA11/50124

§ 371 Date: Dec. 2, 2011

Related U.S. Application Data
(60) Provisional application No. 61/309,175, filed on Mar. 1, 2010.

(51) Int. Cl. F27D 3/12

(52) U.S. Cl. 110/101 R

(57) ABSTRACT

A modular lateral transfer system for use in a horizontally oriented processing chamber is provided. Each module has the ability to deliver process gas in addition to moving the reactant material through the horizontally oriented processing chamber. The modular design enables the operator to remove and replace a module of the system, thereby substantially minimizing the downtime of the chamber required during servicing.

### FIELD OF THE INVENTION

This invention pertains to the field of a lateral transfer system and in particular, to a lateral transfer system for use with a gasifier, incinerator or other high temperature processing chamber.

### BACKGROUND OF THE INVENTION

Lateral transfer systems of high temperature processing chambers such as gasifiers, incinerators, or furnaces are exposed to high thermal stresses. Localized overheating of parts of the lateral transfer system increases corrosion and distortion and causes excessive wear of parts of the lateral transfer system necessitating extensive maintenance of the lateral transfer system. In some systems, overheating may be caused by exposure of parts of the lateral transfer system to the excessive heat and flame emitted during the oxidation of combustible material during the operation. Clogging of air inputs leads to reduced flow, increased back pressure and hampers the circulation of oxygen and therefore can result in a decrease in process efficiency. In addition, if air is used to cool the lateral transfer system clogging of air inputs leads to an increase in thermal stresses. If the air used to cool the system is preheated, the thermal stress is also increased. Maintenance necessitated by lateral transfer system corrosion and air input clogging not only increases the costs of operation but reduces operational time.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a lateral transfer system. In accordance with an aspect of the invention, there is provided a module for use with a lateral transfer system of a processing chamber, the module comprising a module lateral transfer system configured to move a reactant material from a first location to a second location; and one or more module process gas supply systems configured to provide one or more process gases to interact with the reactant material.

### DESCRIPTION OF THE DRAWINGS

Embodiments of the invention will now be described, by way of example only, by reference to the attached Figures, wherein:

FIG. 1 illustrates a generic individual multi-functional lateral transfer and process additive cartridge (1000). The cartridge comprises a cartridge framework (1010) that provides the structure of the cartridge and support for the components therein, a lateral transfer system (1015) and one or more process additive systems (1020).

FIG. 2 illustrates a series of overlapping cartridges (2000) forming a stepped floor moving grate.

FIG. 3 is an alternative view of the moving grate of FIG. 2.

FIG. 4 illustrates a plurality of cartridges (1000) forming a flat grate.

FIG. 5 illustrates one embodiment of the cartridge, which is the individual cartridge (2000) of the moving grate of FIGS. 2 and 3. A multi-piece cartridge framework (2010) provides the structure of the cartridge and support for components therein. The cartridge is attached to the wall of the primary processing unit via a connection plate (2005). The cartridge includes alignment guides (2015) to facilitate the correct insertion of the cartridge into the chamber wall and installation notches (2020) to allow for the insertion of tools to facilitate the insertion and removal of the cartridge. The air box of the cartridge is a composite of multiple smaller air boxes (2025) constructed from thick carbon steel with air holes (2030) in the top of each air box. The air is supplied to the individual air boxes via a single air manifold (2035) connected to an air pipe (2040) which connects to a hot air hook up flange (2045) in the connection plate. The lateral transfer components of the cartridge include a multiple-finger carrier ram (2050). The individual ram fingers comprise a groove configured to engage I-bar shaped (2075) or C-shaped engagement elements (2078) located between individual air boxes and the outside air boxes and the cartridge framework respectively.

FIG. 6 illustrates an alternative view of the individual cartridge of FIG. 5 showing air supply to the individual air boxes via a single air manifold (2035) connected to an air pipe (2040).

FIG. 7 illustrates an alternative view of the individual cartridge of FIG. 5.

FIG. 8 illustrates an alternative view of the individual cartridge of FIG. 5.

FIG. 9 illustrates alternative views of the individual cartridge of FIG. 5.

FIG. 10 illustrates alternative views of the individual cartridge of FIG. 5.

FIG. 11 illustrates alternative views of the individual cartridge of FIG. 5.

FIG. 12 is a schematic representation detailing one embodiment of a cartridge (in part) for a stepped floor processing unit. The cartridge includes alternating layers of thick metal (1019) and ceramic blank (1020) which form a step. Plenums for the introduction of air and/or steam are shown as perforated lines (A, B and C). Air is supplied to the plenums from a header space (not shown). Each plenum is equipped with a nozzle (1021). The step is covered by refractory (1018). Also shown is a reciprocating ram (1022). The drive elements of the cartridge are not shown.

FIG. 13 illustrates one embodiment of the lateral transfer system and air injection cartridge. In this embodiment, air injection (1052) is raised slightly above the surface of the cartridge. The rams (1048) sit on refractory (1018) and are insulated from hot air introduction. Also shown is the air injection header (1055) and the top layer of the solid residue (1056). The drive elements of the cartridge are not shown. The cartridge framework (1010) is also shown. In some embodiments, air injection is replaced by alternative gas process additive injection.

FIG. 14 illustrates one embodiment of the lateral transfer system and air injection cartridge. In this embodiment, to reduce warpage, the air boxes (1030) are constructed as separate, very heavy duty, solid pieces of steel which only inject hot air in areas where uninterrupted/unhindered flow occurs. Air injection is raised slightly above the surface of the cartridge and is through air box holes (1060) with one or more jets, space permitting. The rams (1048) sit on refractory (1018). Between the air box and the refractory, packing insulation (1062) is provided. The air box is further provided with insulation (1059). Also shown are the air injection header (1055) and a seal (1064). The drive elements of the cartridge are not shown. The cartridge framework (1010) is also shown. In some embodiments, air injection is replaced by alternative gas process additive injection.

FIG. 15 illustrates various alternative air injection systems top designs. To reduce warpage, the air boxes are constructed as separate, very heavy duty, solid pieces of steel which only inject hot air in areas where uninterrupted/unhindered flow occurs. Air injection is raised slightly above the surface of the cartridge and is through raised tops with one or more jets, space permitting. The rams (1048) sit on refractory (1018). Between the air box and the refractory, packing insulation (1062) is provided. The air box is further provided with insulation (1059). Also shown is the air injection header (1055), a seal (1064) and spacing (1066). The top of the reactant material is shown by line (1056). The drive elements of the cartridge are not shown. The cartridge framework (1010) is also shown. In some embodiments, air injection is replaced by alternative gas process additive injection.

FIG. 16 illustrates one embodiment of the lateral transfer system and process additive injection cartridge detailing air (1502) and steam (1067) injection, and the air injection header (1055). In this embodiment, the steam is premixed with the air before it is injected into the bed. The top of the reactant material is shown by line (1056). The drive elements of the cartridge are not shown. The cartridge framework (1010) is also shown. In some embodiments, air injection and/or stem injection are replaced by alternative gas process additive injection.

FIG. 17 illustrates one embodiment of the lateral transfer system and process additive injection cartridge detailing air (1502) and steam (1067) injection. In this embodiment, steam is piped in below the air to further buffer the rams from the hot zone. The top of the reactant material is shown by line (1056). The drive elements of the cartridge are not shown. The cartridge framework (1010) is also shown. In some embodiments, air injection and/or stem injection are replaced by alternative gas process additive injection.

FIG. 18 is a side view of a lateral transfer system of one embodiment of the cartridge showing clockwise operation. The top of the cartridge is shown (1029).

FIG. 19 is a side view of a lateral transfer system of one embodiment of the cartridge showing counterclockwise operation. Details of one embodiment of the drive system (1031) are shown.

FIG. 20 shows a top view of a cartridge having the lateral transfer system shown in FIGS. 18 and 19.

FIG. 21 illustrates a horizontally oriented processing unit from the side, and detailing a bottom grate formed from a plurality of one embodiment of the cartridge and detailing the bottom grate positioning of each cartridge (2000).

FIG. 22 illustrates the horizontally oriented processing unit of FIG. 21 in an isometric view.

FIG. 23 illustrates a side view of the horizontally oriented processing unit of FIG. 21 where a cut along the viewing plane allows for internals, such as the moving grate system.

FIG. 24 illustrates a front view of the horizontally oriented primary processing unit of FIG. 21 with a cut to show the inside of the chamber.

FIGS. 25A and 25B illustrate one embodiment for a scraper system (1037) for dealing with potential clinker build up in the cartridge. FIG. 25A shows the side view detailing process additive inputs A, B and C, a scrape guillotine (1036), a scraper slit in side wall (1038) and a hydraulically operated reciprocator (1034). FIG. 25B shows the top view and details the additives manifold (1032), a reciprocating ram (1035), and the scraper trajectory (1039). Optionally, the scraper (1037) is heated.

FIG. 26 is a schematic illustration of an incinerator with a plurality of one embodiment of the cartridges installed.

FIGS. 27A and 27B illustrate an individual cartridge of FIG. 26.

FIG. 28 illustrates a stepped continuous drying apparatus with a plurality of one embodiment of the cartridges installed detailing process additive input through an air box face plate.

FIG. 29 illustrates a flat floor moving grate formed by a plurality of one embodiment of the cartridges.

FIG. 30 is a schematic illustration of a gasifier with a plurality of one embodiment of the cartridges installed. Syngas (1501) is recycled back to the gasifier via the cartridges. Feedstock input (1002) and ash output (1202) are also shown.

FIG. 31 is a schematic illustration of a gasifier with a plurality of one embodiment of the cartridges installed. Syngas (1501) is recycled back to a portion of the cartridges. Air (1502) is provided via the other cartridges. Feedstock input (1002) and ash output (1202) are also shown.

FIG. 32 illustrates a plurality of cartridges forming a moving grate.

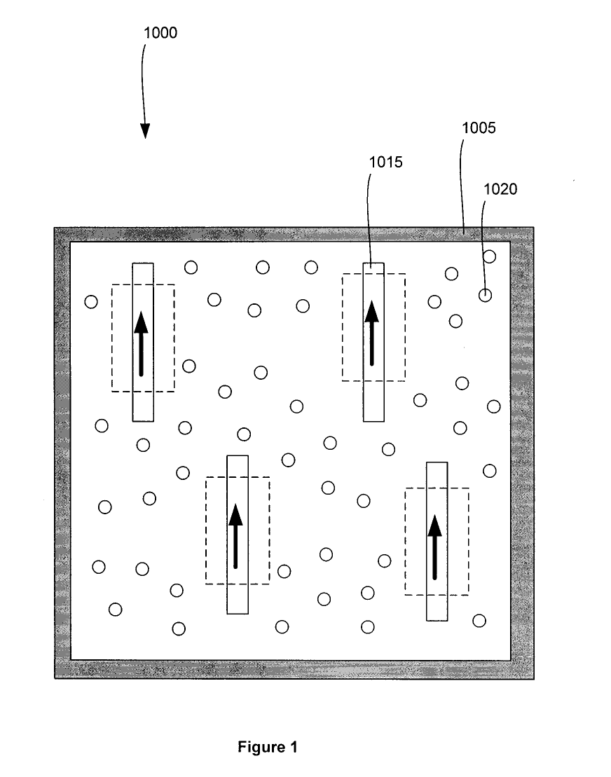

### DETAILED DESCRIPTION OF THE INVENTION

Overview of the System

This invention provides a modular lateral transfer system for use within a horizontally oriented processing chamber such as a gasifier, a dryer, an incinerator, a furnace, a pyrolyzer, a high temperature conveyor type system, a dry distillation apparatus or other reactant material state modification system. The modular lateral transfer system comprises one or more modules, wherein each module comprises the ability to deliver process gas in addition to moving the reactant material through the horizontally oriented processing chamber. The modular design enables the operator to remove and replace a module of the system, thereby substantially minimizing the downtime of the chamber required during servicing.

Each module is configured for interchangeability with the horizontally oriented processing chamber. Accordingly, the chamber comprises one or more insertion locations for positioning of a module, wherein associated with each of the insertion locations is an operative coupling system configured to provide the module with operative connection to systems and/or supplies that enable the module to perform its desired functionality. For example, the operative coupling system can include one or a combination of connections including a power supply connection, a process additive supply connection, an air supply connection, a steam supply connection, a control system connection, a syngas supply connection and the like. According to embodiments, each insertion location of a horizontally oriented processing chamber can be configured to provide a specific combination of connections, which may be dependent on the operation of the chamber and/or the module for insertion at that insertion location. In some embodiments, a complete set of connections is provided at an insertion location, and the use each of these connections can be dependent on the configuration of the module that is inserted into that specific insertion location.

As noted above, each module is configured to deliver process gas in addition to moving the reactant material through the horizontally oriented processing chamber. Accordingly, each module comprises a module lateral transfer system which is configured to move the reactant material from a first location to or towards a second location. Each module further comprises one or more module process gas supply systems, wherein a process gas supply system is configured to at least in part provide a process gas to the reactant material. For example, a process gas can be air, a process additive gas, steam, syngas or the like.

According to embodiments, a module further comprises a module support system which is configured to support both the module lateral transfer system and the module process gas supply system. The support system can additionally comprise a mechanism for the interconnection with the horizontally oriented processing chamber to which the module is to be operatively connected. For example, the mechanism for interconnection can be configured based on structural shape, wherein the mechanism is configured to substantially mate with the configuration of the insertion location of the horizontally oriented processing system. In some embodiments, the module support system. In another example, the mechanism for interconnection can be configured to provide a locking or retention system which is configured to forcibly maintain the positioning of the module with respect to the insertion location, upon placement thereat.

According to some embodiments, upon insertion of a module into an insertion location of the horizontally oriented processing chamber, the module is substantially automatically interconnected to the operative coupling system associated with the chamber. For, example, the operative coupling system can be so configured such that there is a substantially automatic alignment of one or more of power, process gas supplies or others, upon insertion of the module. According to some embodiments, interconnection between a module and the operative coupling system of the chamber requires active coupling therebetween. For example, active coupling can be provided by the connection of mating pipes or electrical connections. In some embodiments, interconnection between a module and the operative coupling system the chamber is a combination of automatic and active coupling.

According to embodiments, a module is configured for lateral transfer of reactant material within the chamber and the supply of air and/or other process additives. According to embodiments, a module is configured as a multi-functional cartridge specifically configured for insertion into the chamber wall. Optionally, the cartridge is configured for rapid replacement and includes a system for the rapid connection of cartridge components to chamber or system components including for example, hot air supplies, process additive supplies, power supplies, control system, etc.

According to some embodiments, a module includes a module lateral transfer system and one or more process gas supply systems configured to supply air. In this embodiment the process gas supply system is configured as one or more air boxes. According to some embodiments, a module includes a module lateral transfer system and a process gas supply system configured to supply one or more process additives. According to some embodiments, a module includes a module lateral transfer system and a process gas supply system configured to supply one or more process additives and air.

According to embodiments, the wall of the horizontally oriented processing chamber is adapted to receive the individual modules at insertion locations configured as slots or openings being provided in the chamber wall for the insertion of the modules. According to embodiments, chambers in which more than one module is to be inserted can include multiple slots or openings. Optionally, individual slots or openings in the chamber wall may be configured to accept more than one module. In some embodiments, the chamber is configured such that adjacent cartridges are inserted from opposite sides of the chamber. According to some embodiments, should a slot or opening within the chamber wall not require the insertion of a module, a plug or other means of sealing that particular slot or slots in the chamber wall may be provided.

According to embodiments, upon installation the one or more modules form, at least part the floor of the processing chamber. According to embodiments, the floor of the processing chamber can be configured to be a substantially flat floor, a sloped floor, a stepped floor or a sloped stepped floor. According to some embodiments, wherein the floor is configured as a stepped floor, each of the modules is configured and oriented in order to provide a single step of the stepped floor.

In some embodiments, when installed, individual modules which are configured as cartridges and are covered, in part, by the cartridge above it, such that only a portion of an individual cartridge is exposed to the interior of the chamber. The slot in which the top most cartridge is inserted is specifically configured such that only a portion of the cartridge is exposed to the interior of the chamber. The cartridges, when installed, form a stepped floor and optionally form a sloped stepped floor to facilitate movement of reactant material while at least in part limiting unprocessed material from tumbling.

According to embodiments, sealing means may be provided between modules and/or between a module and the chamber, wherein the sealing means is configured to prevent egress of material and/or gases into and/or out of the processing chamber and/or between modules. According to some embodiments, a module can be sealed in place using high temperature sealant such as high temperature resistant silicone, temperature resistant gaskets or other suitable sealing device. According to some embodiments, the method of sealing the one or more modules is selected in order to enable ease of removal of a module and insertion of a new or repaired module.

According to some embodiments, a module is reversibly fixed in place by one or more of a variety of fasteners, for example bolts, screws. Optionally, a module can be held in a desired location within the wall of the chamber due to friction. According to some embodiments, an insertion location associated with the wall of the processing chamber can include one or more of insert/position alignment means, connection plates and seals.

According to some embodiments, a processing chamber can be configured to receive a single format of a module, or multiple different formats of a module. A module may be of varying sizes and configurations and may be specifically adapted for the intended use and/or position within the processing chamber and/or the configuration of the processing chamber itself.

According to embodiments, a module is configured to provide lateral transfer of reactant material within the processing chamber and to supply air and/or one or more other process additives. According to these embodiments, the module further comprises a support framework or system configured to provide the structure of the module as well as support for both the lateral transfer system and the air and/or process additive supply system. The module may further comprise a sealing and/or connection system to facilitate the installation of the cartridge into the chamber walls and its securing in position and/or insulation elements.

According to embodiments, the support framework of the module may be constructed of a variety of materials including mild steel, high carbon steel, heat treated steel, an alloy or other material that will be at least in part resistant to the environment in which it is to operate. In addition, the support framework may be configured to facilitate installation and removal, for example, by including notches or attachment sites for tools used in the installation and removal process.

In some embodiments, the lateral transfer system associated with the module is configured to move over the top of a base portion of the module. In this embodiment, air and/or process additives can enter at the base portion of the module or at the bottom of the pile of reactant material wherein the base portion of the module forms a portion of the process gas supply system. The process gas supply system therefore functions as both a process gas supply system and a reactant pile support or chamber floor with reactant material being moved across the surface of the process gas supply system exposed to the interior of the chamber (i.e. the supply surface) by the lateral transfer system. According to embodiments, the process gas supply surface is the top surface of the process gas supply system, the supply surface of the process gas may be a side surface, end surface, sloping end surface or the like. According to embodiments, the configuration of the process gas supply system is, at least in part, dictated by the configuration of the lateral transfer system of the module.

In some embodiments, an individual cartridge comprises both support/connection elements and functional elements. The support/connection elements include the module structure and one or more connection plates specifically configured for sealing connection to the shell of the processing chamber. Refractory may be provided between the module structure and connection plate to reduce heat loss and heat transfer to the connection plate. Once inserted, the module may be secured using appropriate fasteners. The module structure includes alignment guides to facilitate the correct insertion of the module into the chamber wall and notches to allow for the insertion of tools to facilitate the insertion and removal of the module.

Lateral Transfer System of a Module:

Each module comprises a module lateral transfer system which is configured to move the reactant material from a first location to or towards a second location. According to embodiments, the module lateral transfer system comprises one or more moving elements and one or more driving elements. The lateral transfer system optional includes guiding or alignment elements which can provide for the guiding of the movement of the one or more moving elements. According to some embodiments, the module lateral transfer system further includes two or more guide engagement elements which are configured to mesh with the guide elements, and provide a substantially movable interconnection therebetween, thereby facilitating retention of the one or more moving elements in a desired orientation while enabling the desired degree of movement thereof.

In some embodiments, the lateral transfer system and the process gas supply system is configured such that the one or more moving elements of the lateral transfer system moves across the supply surface of the process gas supply system. In such embodiments, the one or more moving elements can include, but is not limited to, a shelf/platform, pusher ram, carrier ram, plow or the like. According to some embodiments, the one or more moving elements can be configured as a single ram or a multiple-finger ram.

In some embodiments the moving elements are configured as rams, and furthermore configured as short rams which can are configured to be fully retracted with each stroke. In some embodiments, which include one or more moving elements configured as a multiple-finger ram design, the multiple-finger ram may be a unitary structure or a structure in which the ram fingers are attached to a ram body, with individual ram fingers optionally being of different widths depending on location.

In some embodiments, which include a moving element configured as a multiple-finger ram, there is a separation space between each of the multiple finger of the multiple finger ram. This separation space can be configured in order to allow for expansion of the respective multiple fingers during operation of the processing chamber. For, example, the separation space may be determined at least in part based on the maximum operating temperature of the processing chamber.

According to some embodiments, a moving element is configured as a “T-shaped” moving element.

In some embodiments, the lateral transfer system and the process gas supply system of a module is configured such that the moving element is inserted or embedded within the supply surface of the process gas supply system. In such embodiments, the one or more moving elements can be configured as, but not limited to, a screw element, one or more wheel elements, a conveyor element or the like.

According to embodiments, the one or more moving elements are constructed of material suitable for use at high temperature. Such materials are well-known to those skilled in the art and can include stainless steel, mild steel, or mild steel partially protected with or fully protected with refractory or the like. The one or more moving elements may optionally be of a cast or solid construction. Optionally the one or more moving elements are sized and/or configured to ensure any sized or shaped agglomeration is effectively moved. For example, as the reactant material changes in shape and/or properties, the one or more moving elements are configured to move the reactant material regardless of these changes.

According to embodiments, the module lateral transfer system includes one or more guide elements which are positioned such that they are exposed to the interior of the chamber. In some embodiments, the one or more guiding elements are positioned such that they are at least in part isolated from the interior of the processing chamber.

In embodiments in which the guide elements are exposed to the interior of the chamber, the lateral transfer system can be designed to prevent jamming or debris entrapment. According to some embodiments a guide element can be configured as one or more guide channels located in the side walls of the cartridge, one or more guide tracks or one or more rails, one or more guide troughs, one or more guide chains or the like.

According to some embodiments, the module lateral transfer system includes one or more guide engagement members which are configured to movably engage with one or more of the guide elements. The one or more guide engagement members optionally include one or more wheels or rollers sized to movably engage the guide element. In some embodiments, the guide engagement member is a sliding member comprising a shoe adapted to slide along the length of a guide track.

In some embodiments, the one or more guide engagement elements can be integral to or integrally formed with a moving element. For example, the surface of a moving element may be specifically adapted to engage with one or more of the one or more guide elements. In some embodiments, the supply surface of the process gas supply system includes tracks and the one or more moving elements in contact with the supply surface are specifically shaped to engage the tracks.

According to embodiments, the lateral transfer system of a module includes a multiple-finger carrier ram, engagement elements and drive system. Individual ram fingers are attached to a ram body via pins or shoulder bolts, which are configured to substantially not tighten on the individual finger. The ram body is connected to a drive engagement plate that includes parallel racks for operative engagement with a pinion for movement thereof. In some embodiments, the individual ram fingers are configured to engage a T, C or I-bar shaped engagement element which holds the ram fingers in proximity to the surface of the air box such that the rams substantially scrape the air box surface during back and forth movement thereby aiding in avoiding clinker build up.

According to some embodiments, the end of a ram finger is bent down to ensure that the tip contacts the top of the air box in the event that the relative locations of the ram and air box change due, for example, to thermal expansion or contraction of one or more components. This configuration of a ram finger may also lessen detrimental effects on the process due to air holes being covered by the ram, the air will continue to flow through the gap between the ram and air box.

According to embodiments, each of the modules include the drive components necessary to effect movement of the one or more moving elements associated with the module lateral transfer system. For example a drive component can include a chain drive, sprocket drives, rack and pinion drive or other drive component configuration as would be readily understood. According to some embodiments, the drive component further comprises one or more actuators, pumps electrical motors or other mechanism used to operate the drive component. According to some embodiments, the provision of operative power for the respective drive component is provided by the processing chamber itself, wherein this required operative power can be enable upon operative interconnection of the module with the processing chamber. Optionally, in a configuration which includes multiple modules, operative power for the each of the module lateral transfer systems can be provided by one or more selected modules. In this manner, the there may be a reduction in costs associated with some of the modules as the operative component does not have to be integrated therein.

According to embodiments, power for moving the one or more moving elements is provided by a hydraulic piston. For example, power to propel the one or more moving elements is supplied by a hydraulic piston which drives one or more pinions on a shaft via a rotary actuator selectable in the forward or reverse direction allowing for extension and retraction of the one or more moving elements at a desired rate. In some embodiments, two pinions are used and engage respective parallel racks operatively connected to the one or more moving elements. According to some embodiments, position sensors can be positioned to detect and transmit position information regarding the one or more moving elements to an operatively connected control system.

Process Gas Supply System of a Module

Each module further comprises one or more module process gas supply systems, wherein a process gas supply system is configured to at least in part provide a process gas to the reactant material. For example, a process gas can be air, a process additive gas, steam, syngas or the like.

According to embodiments, process gas is provided to the interior of the processing chamber through or at the supply surface associated with the module. The process gas supply system may be configured to provide air only or a combination of air and/or one or more process additives either through shared inlets or dedicated inlets.

According to embodiments, the process gas supply system comprises a delivery system, wherein the delivery system may be configured to provide a distributed supply or a more focused supply of air and/or one or more process additives. For example a distributed supply configuration can include a supply surface which is perforated or comprises a series of holes. A more focused supply of air and/or one or more process additives may be provided by the use one or more nozzles. In some embodiments, the injection of air and/or one or more process additives is provided at a location which is raised slightly above the supply surface. This positioning of the provision of the air and/or one or more process additives can be provided by the use of raised inputs.

In some embodiments, the supply surface associated with the process gas supply system includes a plurality of perforations. According to some embodiments, the number of perforations can be optimized to provide additives and/or heat circulation throughout the reactant material.

In some embodiments, the air supply to a single module may be independently controlled or the air pipes to two or more modules may be connected to a single manifold such that the air supply to the two or more modules is dependently controlled.

In some embodiments wherein the process gas supply system includes one or more nozzles, the nozzles can be configured as low, medium or high flow nozzles. This can be enabled by varying nozzle diameters and can allow for low, medium or high penetration of the process gas being supplied. This configuration of the process gas supply system can be configured to cover the reactant material location are more uniformly.

In some embodiments, hole patterns associated with the process gas supply system are arranged such that operation of the lateral transfer unit does interfere with the process gas passing through the holes. In some embodiments, the pattern of holes facilitates the even distribution of one or more process additives or air over a large surface area with minimal disruption or resistance to lateral material transfer.

In embodiments wherein a multiple-finger ram is used as the moving element, the pattern of the holes is configured such that when heated the holes are between the fingers (in the gaps). In some embodiments, the holes can be configured in an arrow pattern with an offset to each other. In some embodiments, the hole pattern can also be hybrid where some holes are not covered and others are covered, such that even distribution of process gas is substantially maximized (i.e. areas of floor with substantially no process gas input at all are substantially minimized).

In some embodiments, the process gas inputs provide diffuse, low velocity input of process gas. In some embodiment, diffuse, low velocity input is provided for the process additives.

In some embodiments, the process gas supply system further comprises air boxes, manifolds and piping as necessary. In some embodiments, hot air is provided through air boxes. Optionally, the air boxes are cast and moulded unitary inserts. The functional elements include one or more air box components and one or more lateral transfer components.

In some embodiments, the air box component may include multiple smaller air boxes or a single large air box. Optionally the air boxes are specifically configured to reduce distortion, to reduce the risk of stress-related failure or buckling of the air box. In some embodiments, the individual air boxes are constructed from thick carbon steel. In some embodiments, to reduce warpage the air boxes may be constructed as separate, very heavy duty, solid pieces of steel which only inject hot air in areas where uninterrupted/unhindered flow occurs.

In some embodiments, the material for the perforated top plate of the air boxes is an alloy that meets the corrosion resistance requirements for the overall system. If the perforated top sheet is relatively thin stiffening ribs and structural support members to prevent bending or buckling may be provided, for example.

In some embodiments, air enters the processing chamber at the bottom of the pile of reactant material through air holes or perforations in the top of each air box. If the individual modules include multiple air boxes, air may be supplied to the individual air boxes via a single air manifold connected to an air pipe which connects to a hot air hook up flange in the connection plate. A hot air hook up flange is optionally adapted to facilitate rapid connection to a hot air supply.

In some embodiments, in order to avoid blockage of the air holes during processing, air hole size in the perforated tops of the air boxes is selected such that it creates a restriction and thus a pressure drop across each hole. This pressure drop can be sufficient to prevent particles from entering the holes. The holes can be tapered outwards towards the upper face to preclude particles becoming stuck in a hole. In addition, the movement of the lateral transfer units may dislodge any material blocking the holes.

Applications

The cartridge is configurable for use in a variety of high temperature chamber where lateral conveyance of material is required including furnaces, gasifiers, incinerators, dryers, pyrolyzers, high temperature conveyor systems, and among others.

Generally, a plurality of cartridges would be mounted in an optionally refractory-lined chamber to form a moving grate. The chamber includes one or more inlets configured to input material, an exhaust or gas outlet, and a processed material outlet or removal system.

In one embodiment, the cartridge is configured for use in a gasifier. The gasifier may be generally horizontally oriented and is configured to convert carbonaceous feedstock to syngas and a solid reside.

In one embodiment, the cartridge is configured for use in an integrated multi-fuel gasifier, for example, as disclosed in European Patent Application No. 1 696 177. In such an embodiment, the cartridge would replace the drying syngas and pusher, recirculated syngas and pusher, and air and pusher.

In one embodiment, the cartridge is configured for use in an incinerator.

In one embodiment, the cartridge is configured for use in a starved air incinerator.

In one embodiment, the cartridge is configured for use in a step stoker incinerator.

In one embodiment the cartridge is configured for use in a dry distillation apparatus.

In one embodiment the cartridge is configured for use in a semi-continuous dry distillation apparatus as disclosed in KR20050025190.

In one embodiment the cartridge is configured for use in an incinerator as disclosed in U.S. Pat. No. 4,172,425. In particular, the cartridge would replace the ram and air supply of the disclosed incinerator.

In one embodiment, the cartridge is configured for use in an apparatus configured to recycle oil laden waste as disclosed in U.S. Pat. No. 5,944,034. In particular, the cartridge is configured for use in a chamber designed to lower the viscosity of the oil so it will drain from the products, and volatize (but not burn) the oil into a vapor which then carried to the oil condensing or reclamation chamber. The cartridges would be optionally configured with collection grooves to direct oil flow to a collection point and/or drainage conduits.

In one embodiment, the cartridge is configured for use in a drying apparatus.

### EXAMPLES

Cartridge for Use with a Horizontally-Oriented Gasifier

In one embodiment, the cartridge is configured for insertion into a horizontally-oriented gasifier. When installed, the plurality of cartridges forms the stepped moving grate of the gasifier. Individual floor levels correspond to a combined lateral transfer and air input cartridge such that a plurality of these cartridge (2000) form the moving grate.

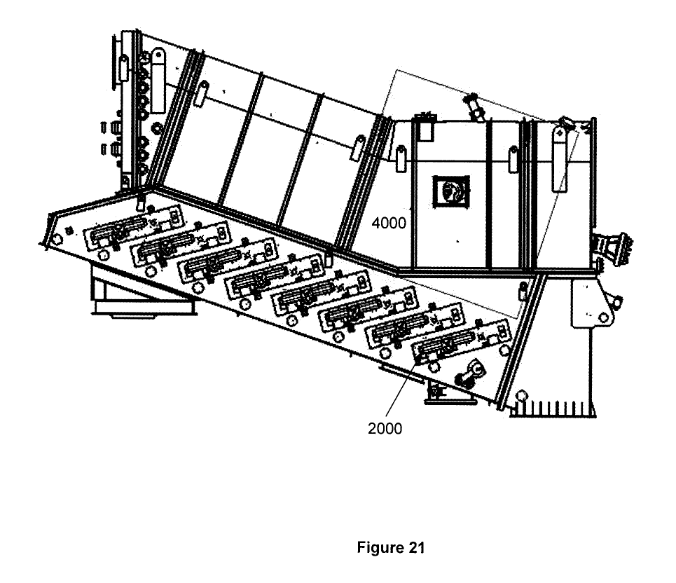

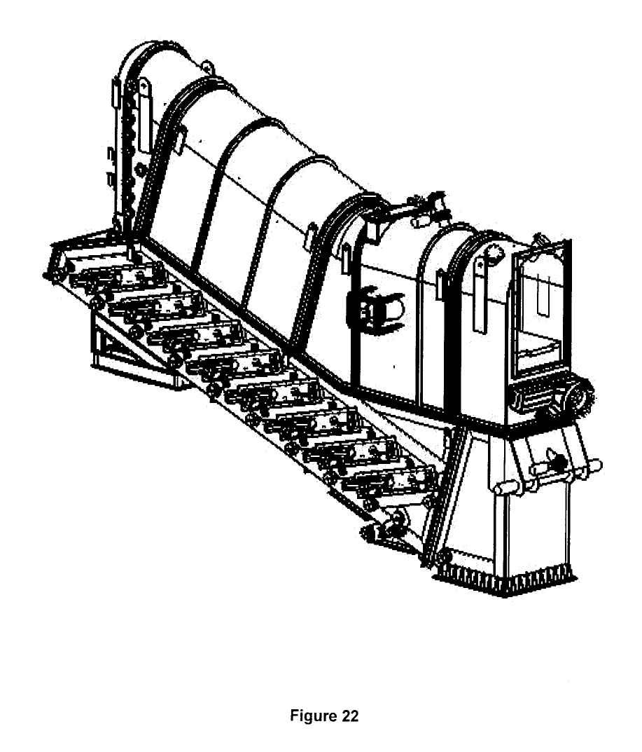

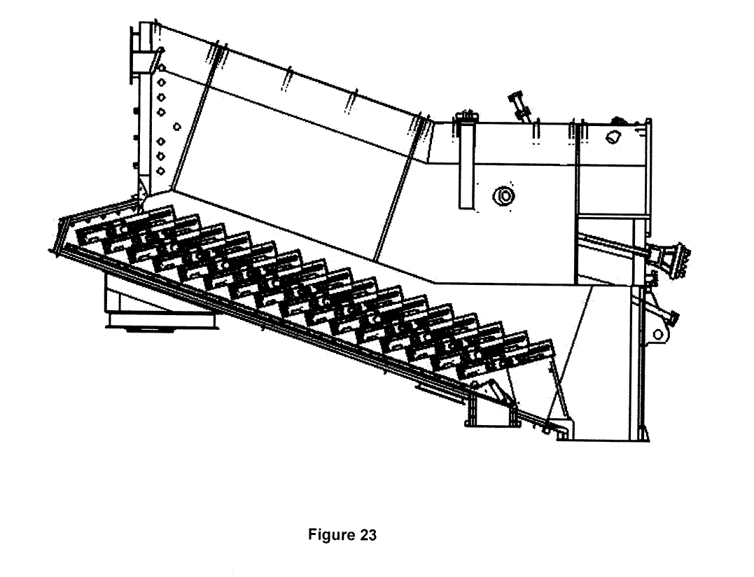

Referring to FIGS. 21 to 24, there is provided a horizontally oriented gasifier (4000) (shown in part), comprising a horizontally-oriented refractory lined chamber having a feedstock input, gas outlet, a solid residue outlet, and various service and access ports. The gasification chamber has a stepped floor with a plurality of floor levels. Each individual cartridge (2000) corresponds to an individual step and is oriented in the chamber such that the floor level is sloped to facilitate movement of reactant material through the gasifier without tumbling of unprocessed feedstock.

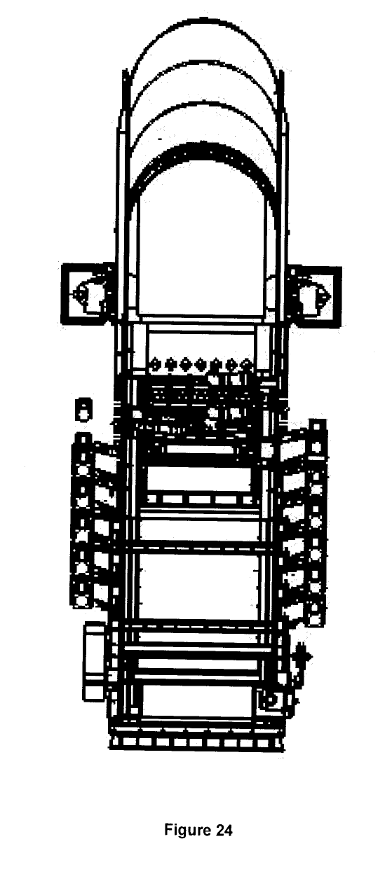

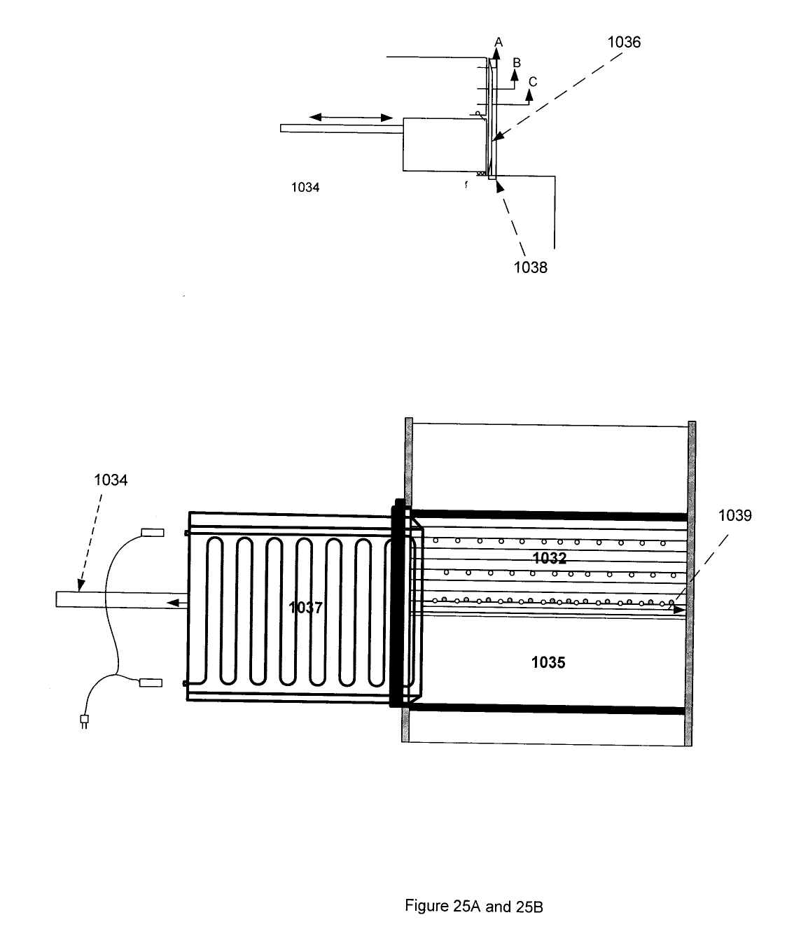

The side walls of the gasifier are provided with opening for the insertion of the individual cartridges. Adjacent cartridges are inserted from opposite sides of the unit (see FIG. 24). When installed, individual cartridges are covered, in part, by the cartridge above it, such that only a portion of an individual cartridge is exposed to the interior of the unit.

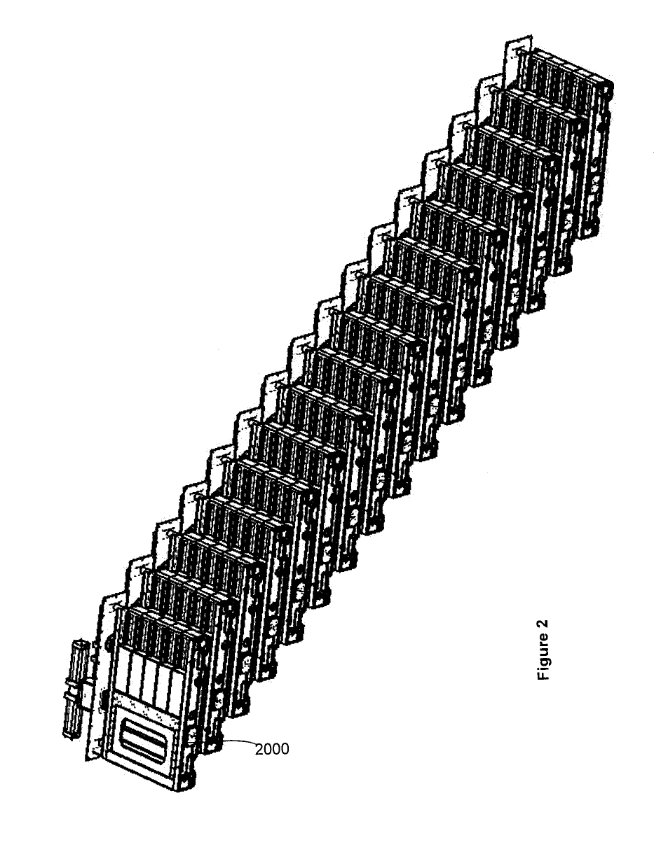

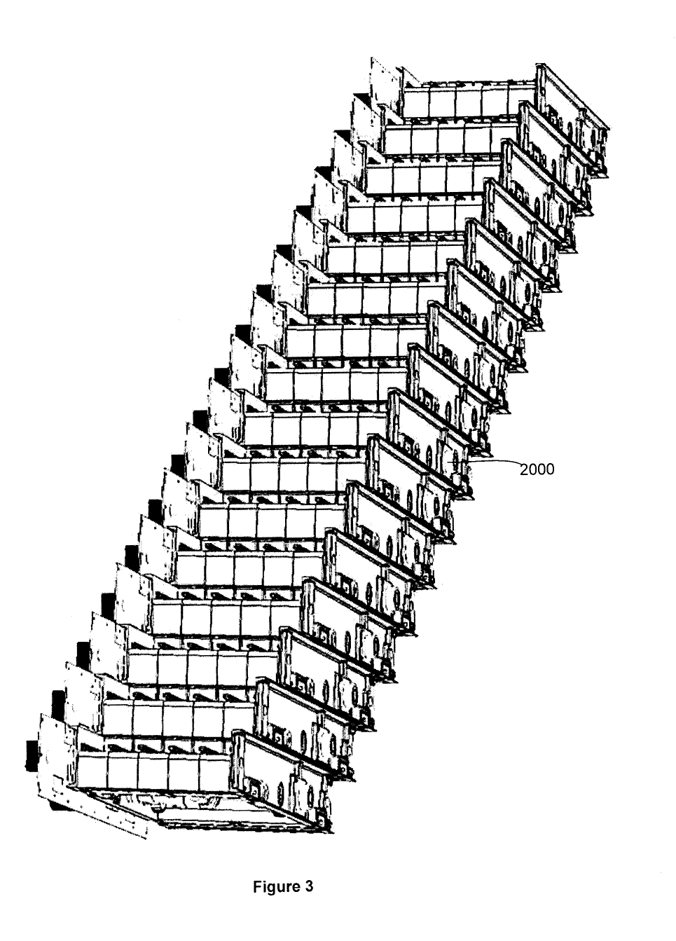

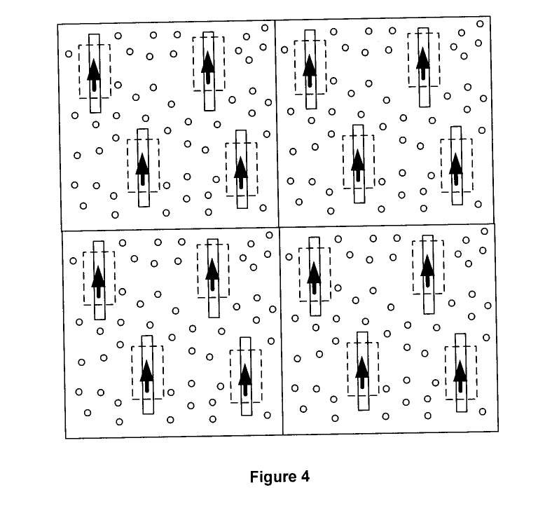

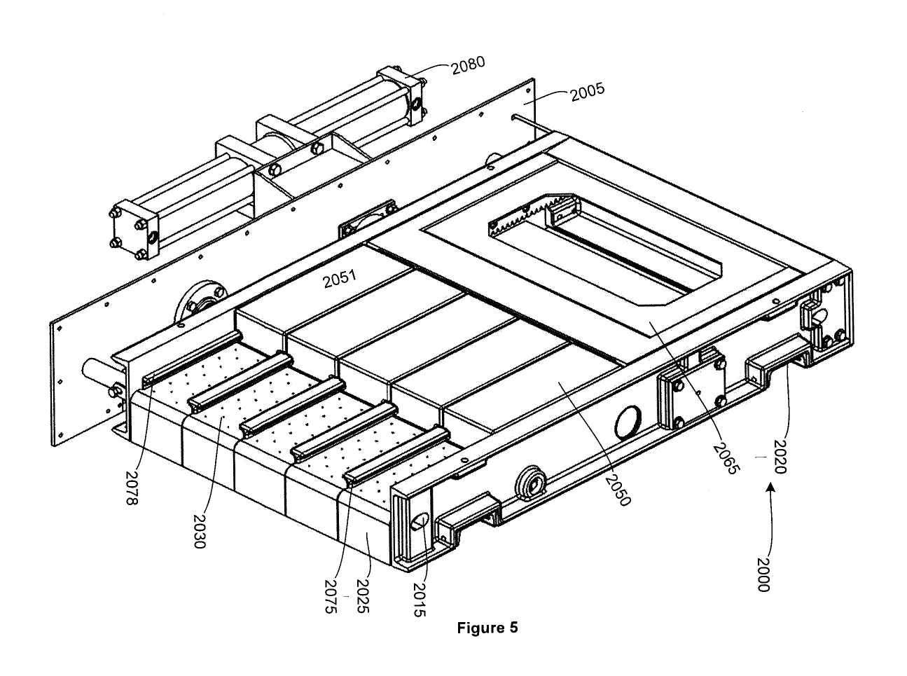

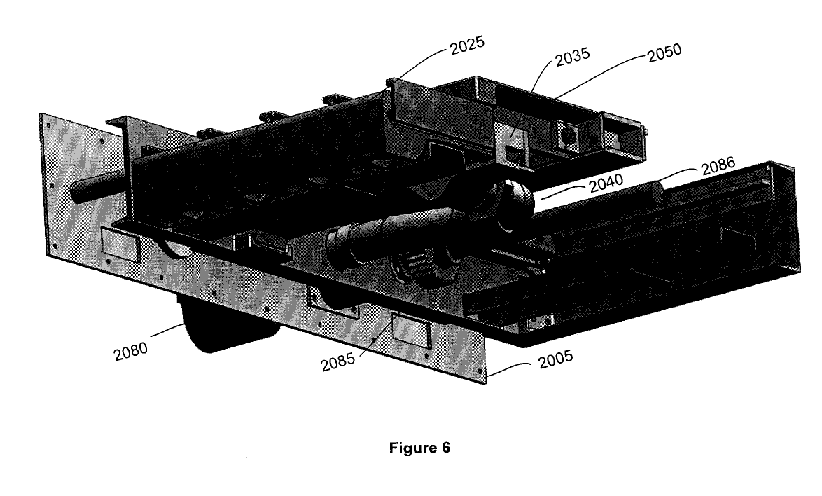

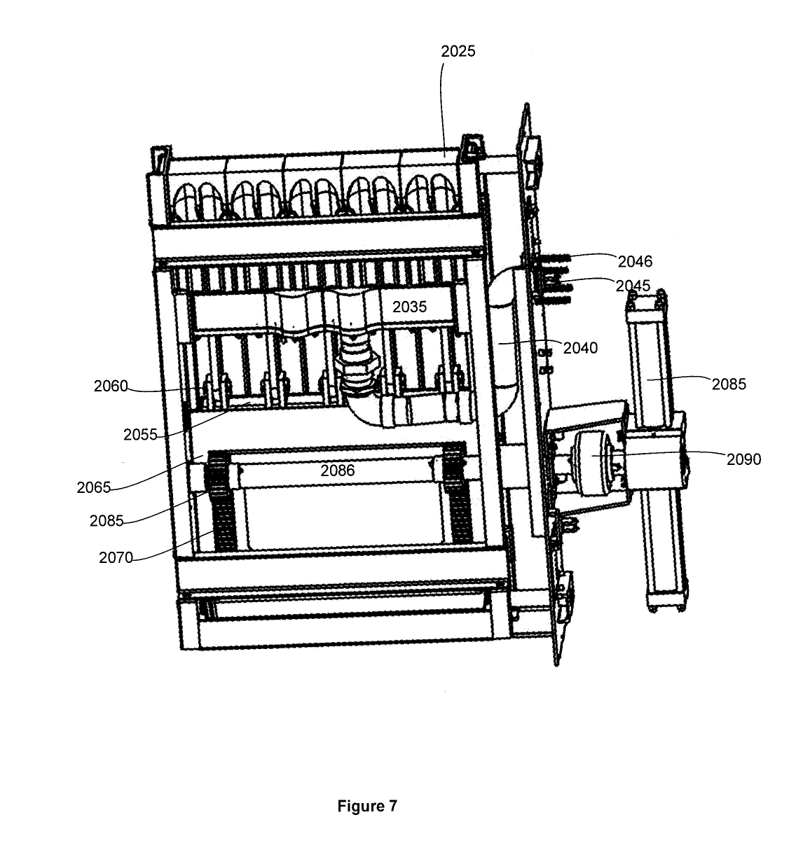

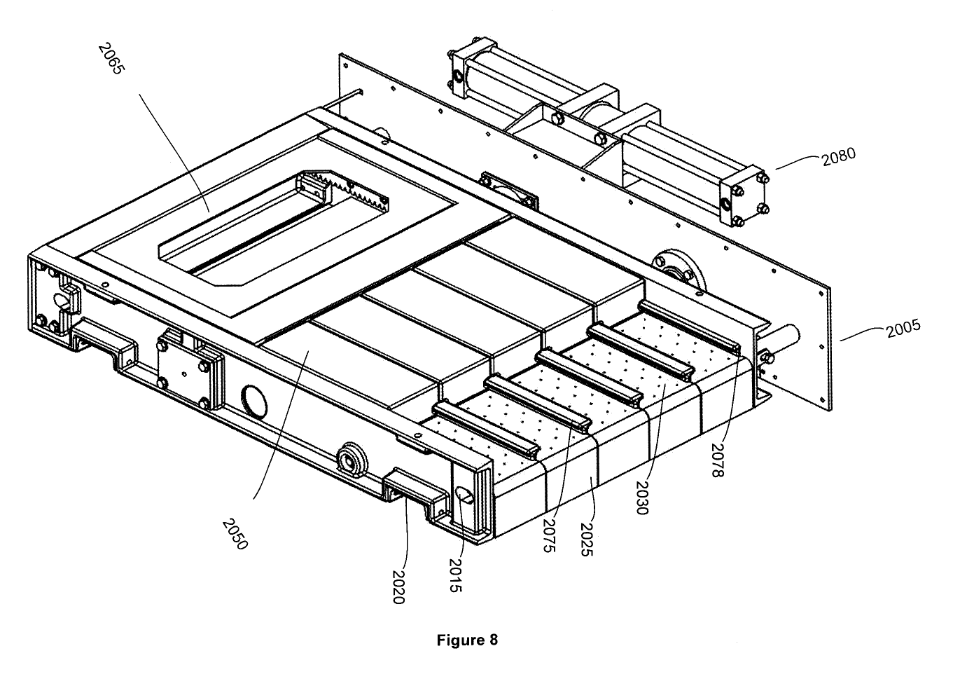

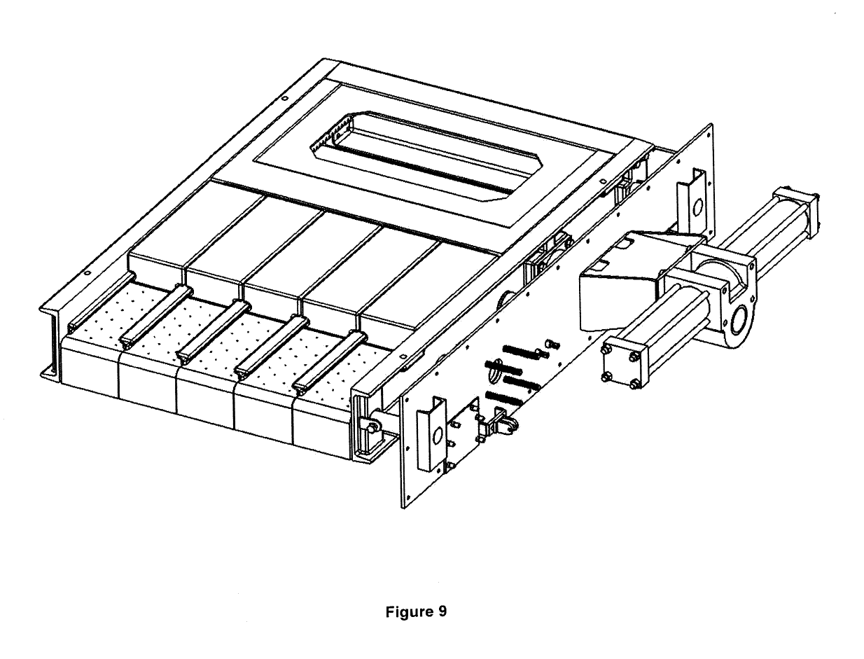

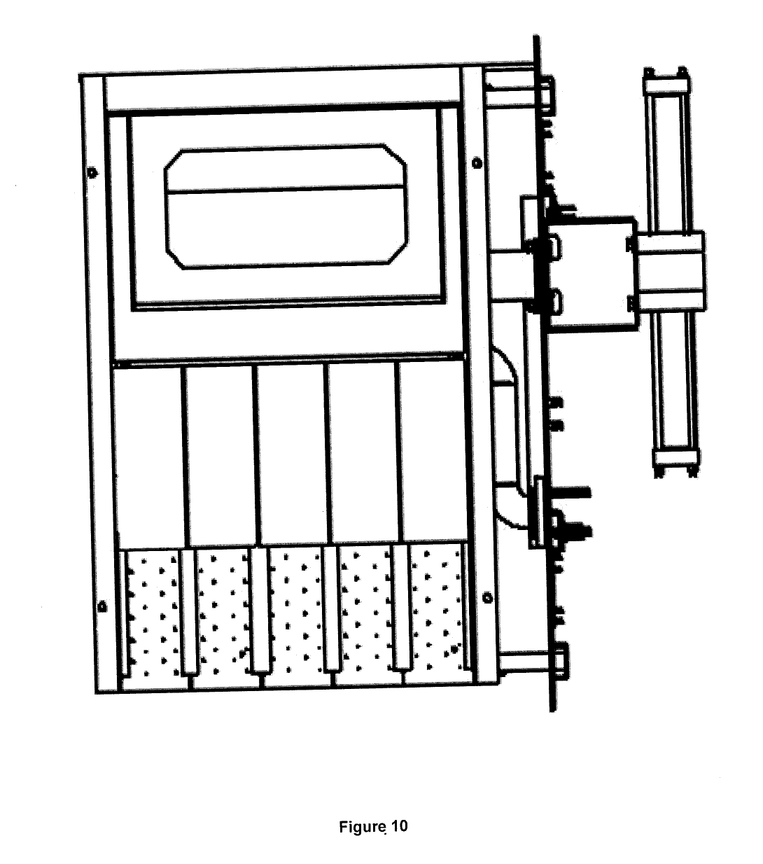

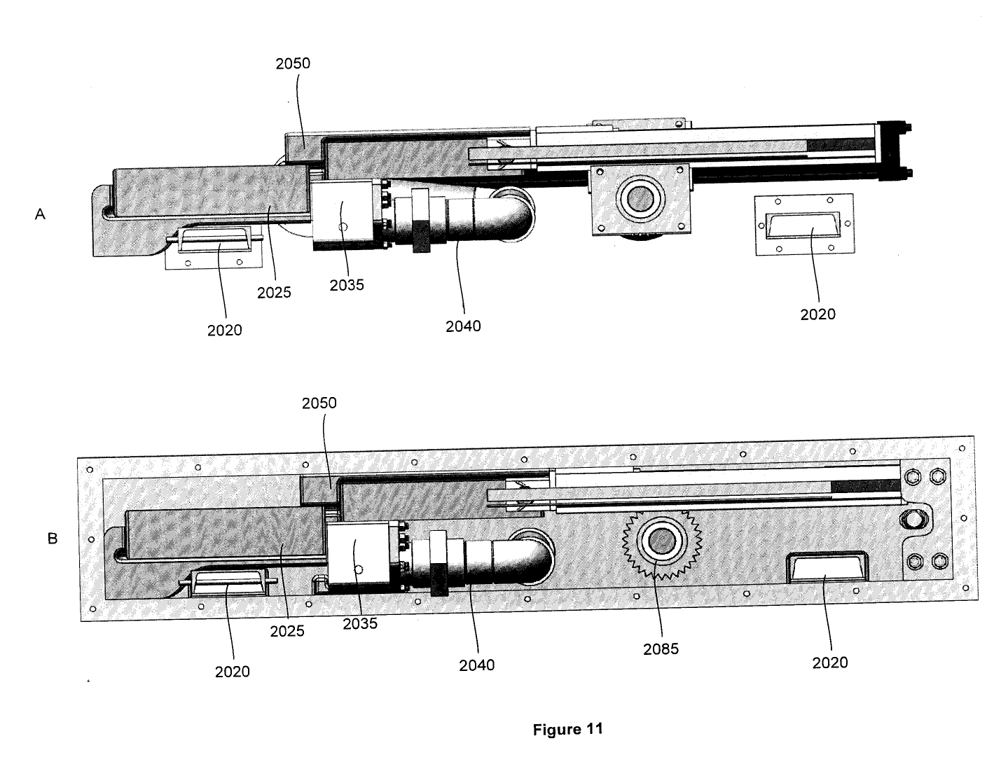

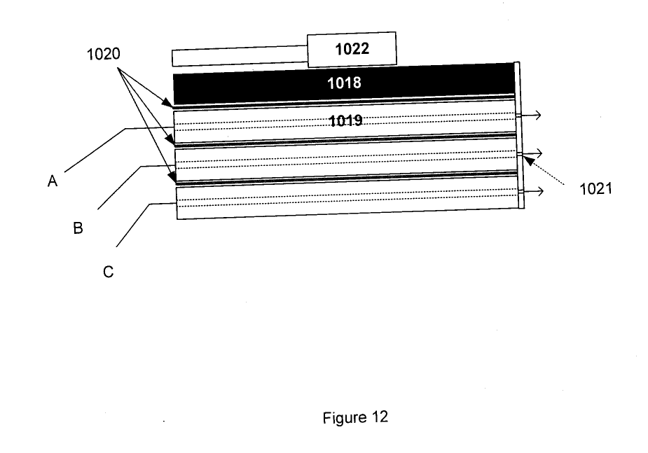

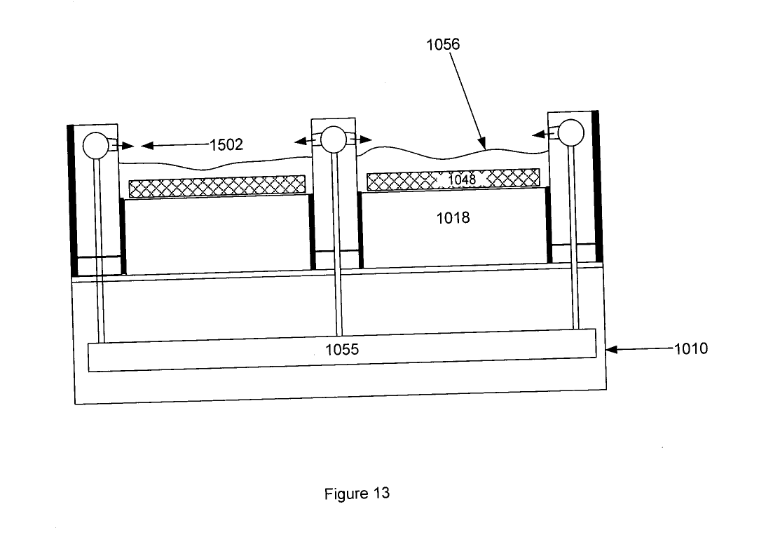

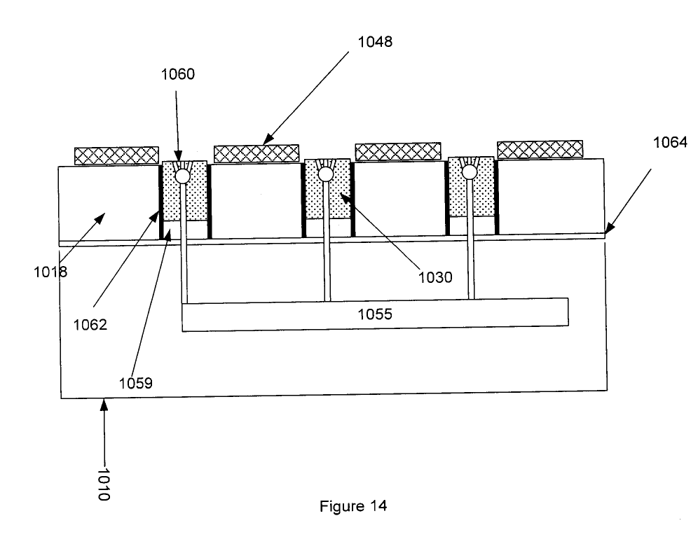

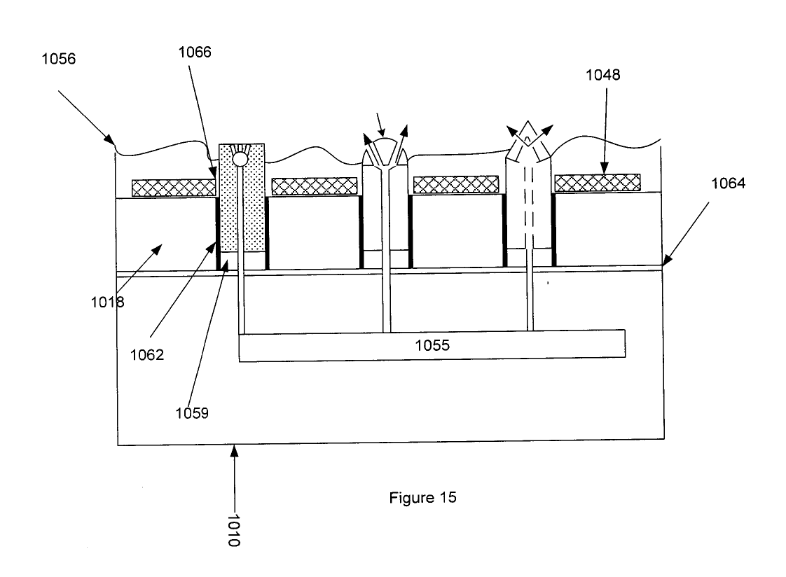

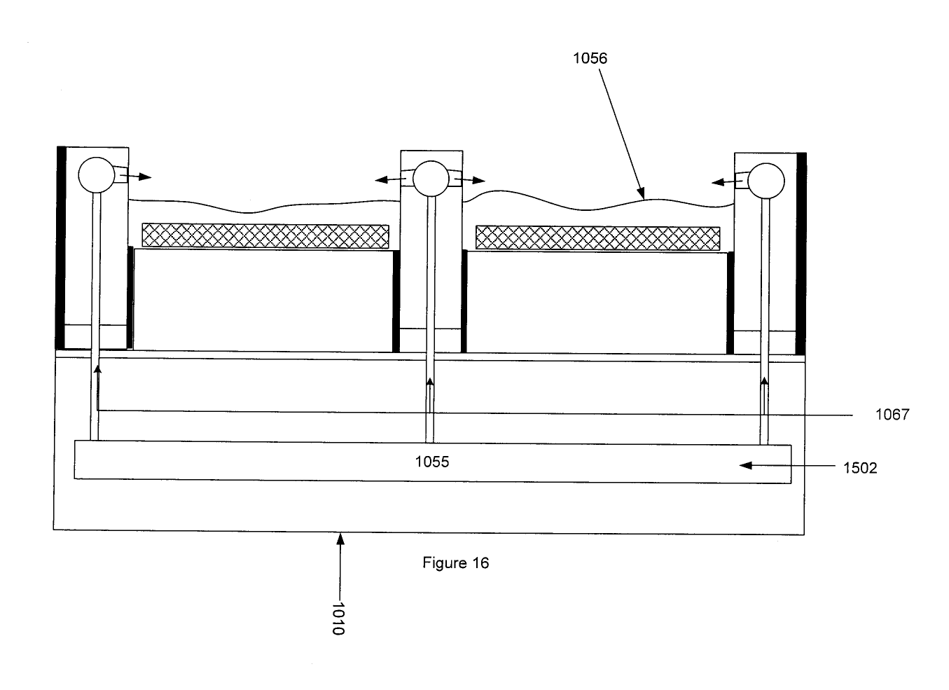

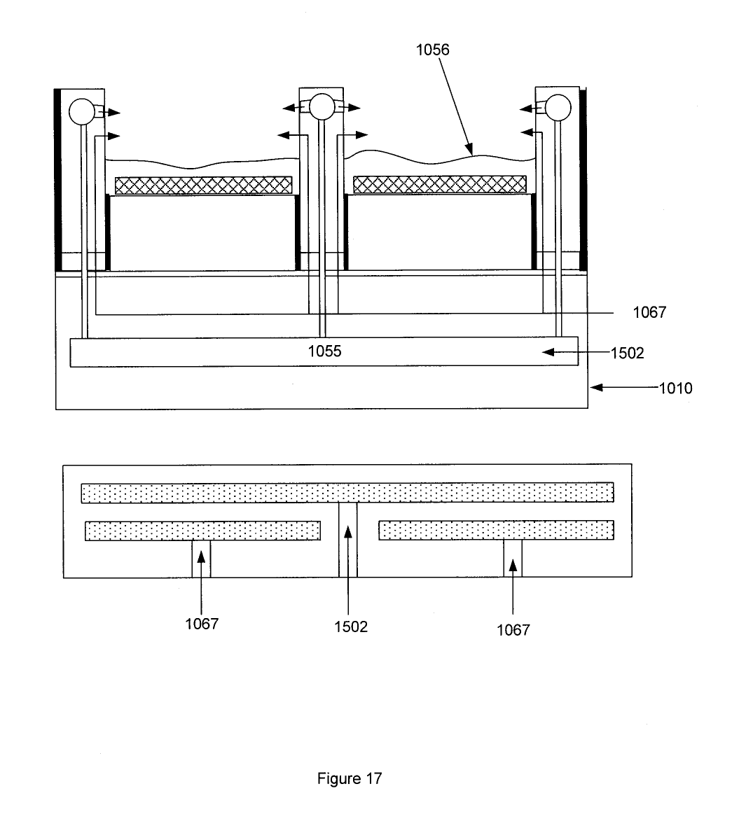

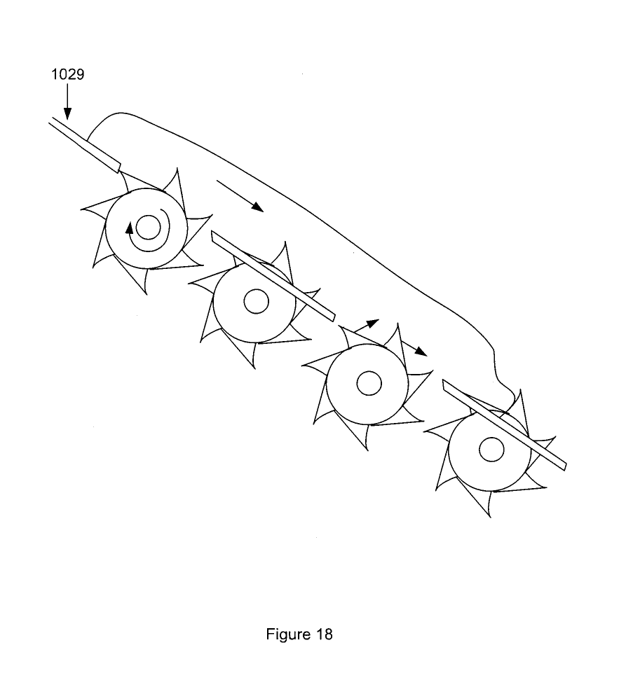

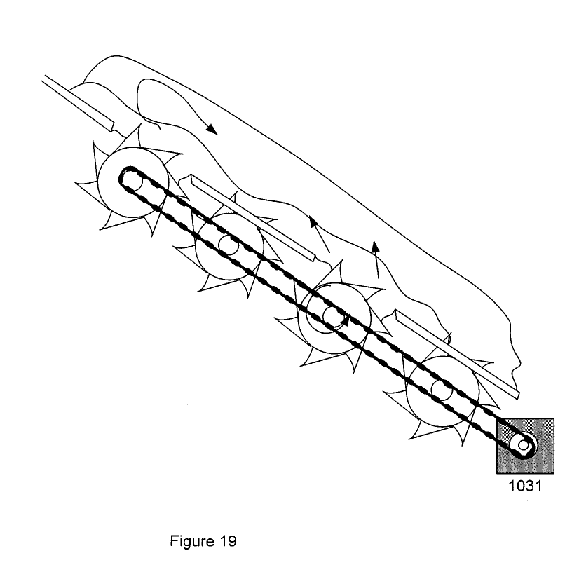

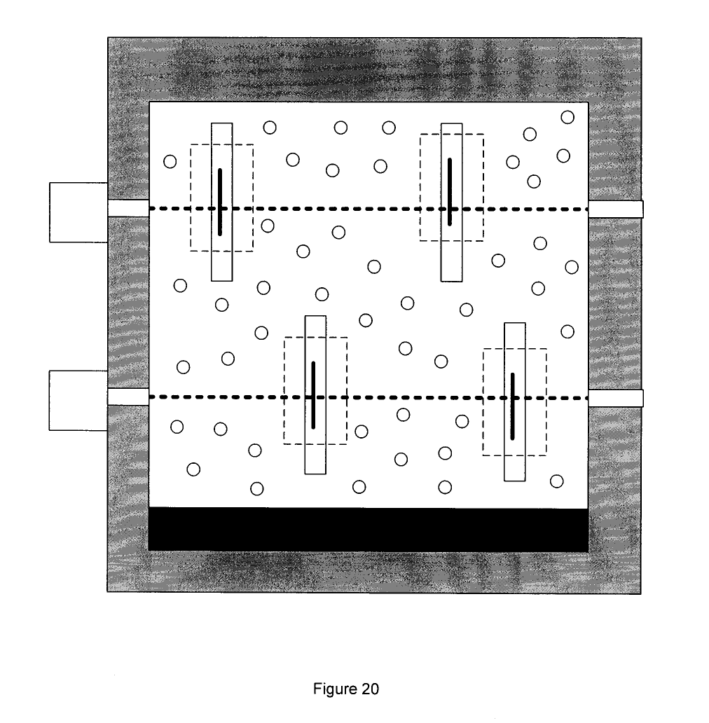

Referring to FIGS. 2, 3 and 21 to 24, a series of individual cartridges in situ forms a moving grate (4002). An individual cartridge (2000) comprises both support/connection elements and functional elements. Referring to FIGS. 5 to 11, the support/connection elements include the cartridge framework (2010) and connection plate (2005) specifically configured for sealing connection to the shell of the primary processing unit. Refractory (not shown) is provided between the cartridge structure and connection plate (2005) to reduce heat loss and heat transfer to the connection plate. Once inserted, the cartridges are secured using appropriate fasteners. The cartridge includes alignment guides (2015) to facilitate the correct insertion of the cartridge into the chamber wall and installation notches (2020) to allow for the insertion of tools to facilitate the insertion and removal of the cartridge from the primary processing unit.

The functional elements of the cartridge include air box components and lateral transfer components. The air box of the cartridge is a composite of multiple smaller air boxes (2025) constructed from thick carbon steel.

Air enters the gasifier at the bottom of the pile of reactant material through air holes (2030) or perforations in the top of each air box (2025). The air is supplied to the individual air boxes via a single air manifold (2035) connected to an air pipe (2040) which connects to a hot air hook up flange (2045) in the connection plate. The connection plate further includes inputs for thermocouples (2046).

The lateral transfer components of the cartridge include a multiple-finger carrier ram (2050), engagement elements and drive system. Individual ram fingers (2051) are attached to a ram body (2055) via pins or shoulder bolts (2060), which do not tighten on the individual finger. The ram body is connected to a drive engagement plate (2065) that includes two parallel racks (2070).

The individual ram fingers (2051) comprise a groove configured to engage an I-bar shaped (2075) or C-shaped engagement elements (2078) located between individual air boxes and the outside air boxes and the cartridge framework respectively. The engagement elements which hold the rams in proximity to the surface of the air box such that the rams scrape the air box surface during back and forth movement thereby avoiding clinker build up.

Power for moving the multiple-finger ram is provided by a hydraulic piston (2080). Briefly, in the illustrated embodiment, power to propel the ram is supplied by a hydraulic piston (2080) which drives two pinions (2085) on a shaft (2086) via a rotary actuator (2090) selectably in the forward or reverse direction allowing for extension and retraction of the rams at a controlled rate. Position sensors transmit ram position information to the control system. Two pinions (2085) engage parallel racks (2070) on the drive engagement plate (2065).

Cartridge for Use with a Stroker Incinerator

In one embodiment, the cartridge is configured for insertion into an incinerator thereby providing a reciprocating type of stoker suitable for use in municipal, industrial and commercial incinerators which is operative to tumble refuse deposited thereon to enhance the combustion process as the refuse transits the length of the stoker.

In one embodiment, the incinerator comprises an elongated casing defining a generally horizontal combustion chamber. Slots are provided in along both sides of the casing for the insertion of individual cartridges. When installed, individual cartridges are covered, in part, by the cartridge above it, such that only a portion of an individual cartridge is exposed to the interior of the unit.

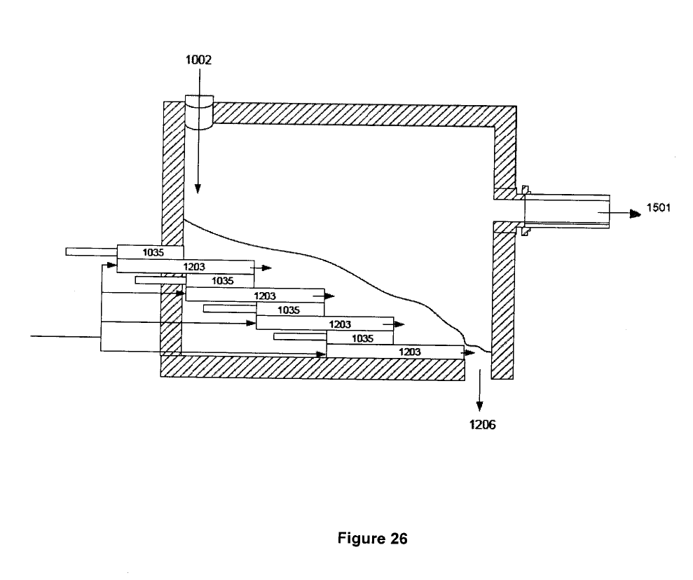

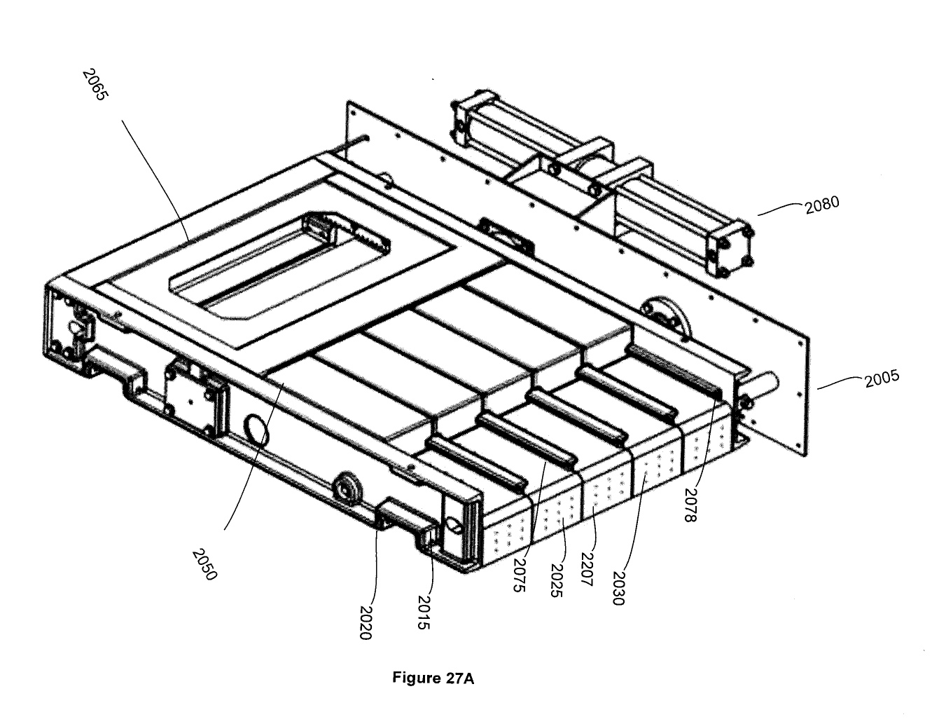

Referring to FIG. 26, the combustion chamber includes an inlet (1002) for waste material, an outlet for ash (1206), optionally equipped with an ash extractor screw, exhaust (1501) and optional burner port (1273). The individual cartridges in situ form a stepped floor and each step optionally defines a separate burning area for waste material at a different elevation.

Each cartridge includes a reciprocating ram (1035) having a pusher wall defining a portion of the riser when in a retracted position. The ram is that is movable across the surface of the cartridge exposed to the interior of the chamber to an extended position to move burning waste material thereon further towards the outlet end of the combustion chamber. Air injection is through nozzles or perforations in the face plate of the cartridge (2207).

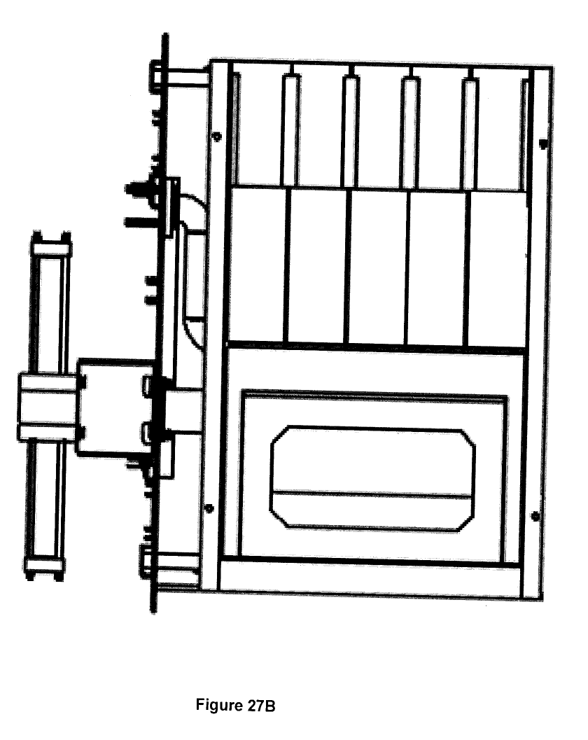

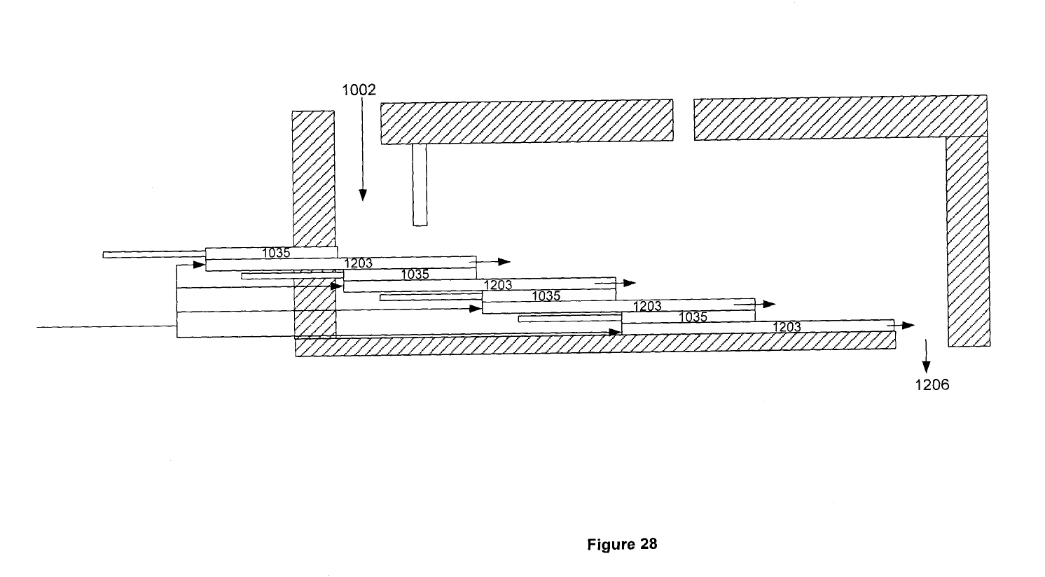

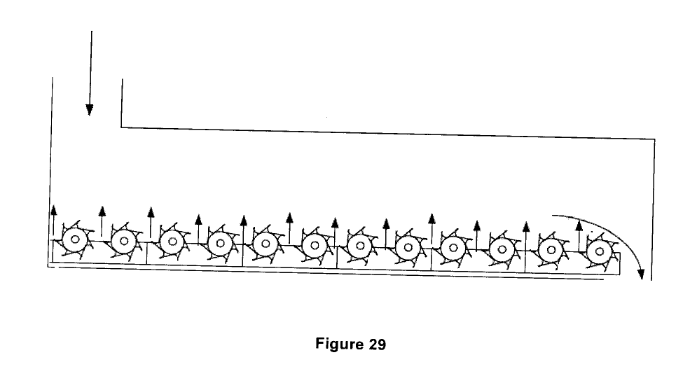

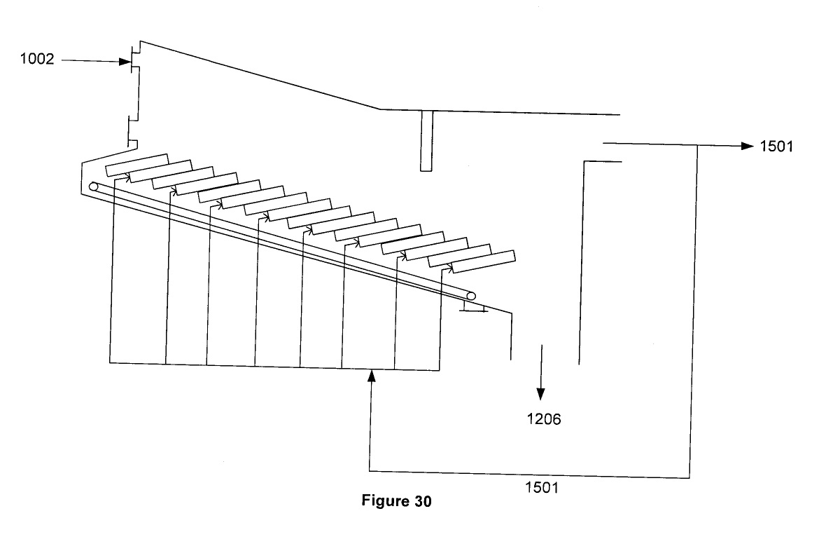

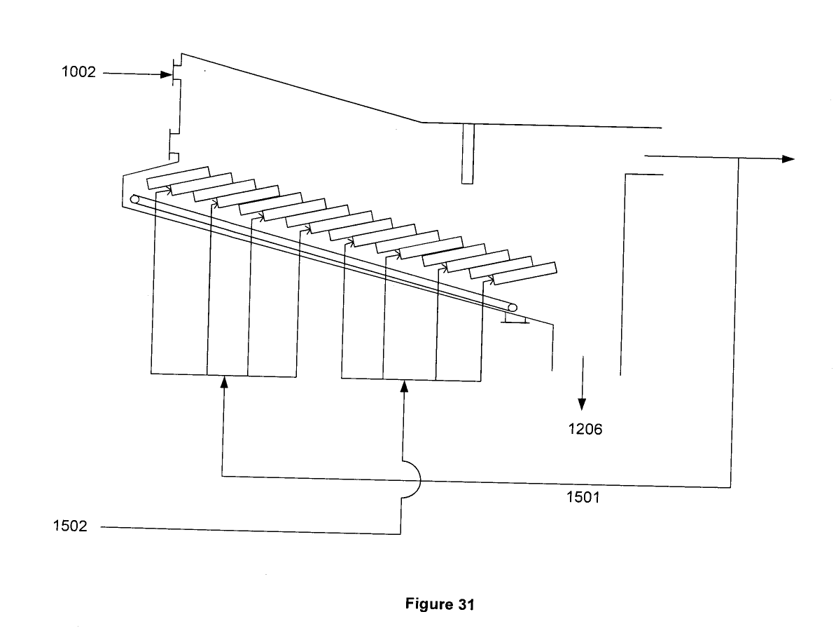

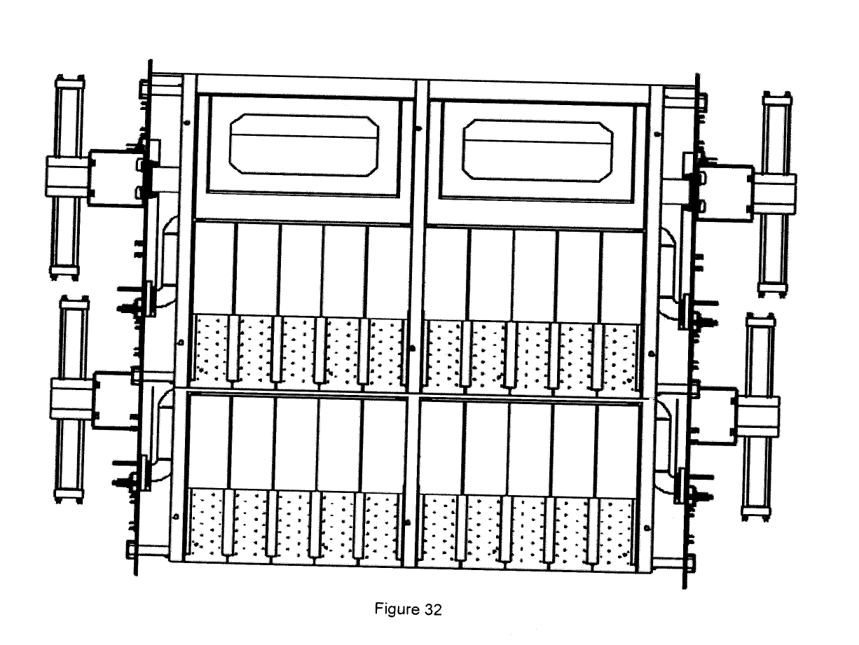

The cartridge structure is generally as described above. Briefly, referring to FIG. 27, each cartridge includes a cartridge framework (2010) and connection plate (2005) specifically configured for sealing connection to the shell of the incinerator. Air enters the incinerator through air holes (2030) or nozzles in the face plate (2207) of each air box (2025). Air supply is to the individual air boxes as described above.

The lateral transfer components of the cartridge include a multiple-finger carrier ram (2050), engagement elements and drive system and are as described above.

1. A module for use with a lateral transfer system of a processing chamber, the module comprising:
a module lateral transfer system configured to move a reactant material from a first location to a second location; and
one or more module process gas supply systems configured to provide one or more process gases to interact with the reactant material.

2. The module of claim 1, wherein the module is configured for use in a furnace, gasifier, incinerator, dryer, pyrolyzer, high temperature conveyor system, or dry distillation apparatus.

3. The module of claim 1, wherein the one or more process gases is air, oxygen, steam, syngas, hydrocarbon or oxygen-enriched air.

4. The module of any one of claim 1, wherein the module lateral transfer system comprises a lateral transfer unit comprising a shelf, platform, ram, plow, screw, carrier ram, conveyor, belt or toothed wheel.

5. The module of claim 4, wherein the ram is a multi-finger ram.

6. The module of claim 1, further comprising one or more cooling devices, the one or more cooling devices optionally operatively associated with one or more sensing or response elements.

7. The module of claim 1, wherein the one or more module process gas supply systems are configured to provide one or more process gases through a top plate of the module or through a face plate of the module.

8. The module of claim 1, wherein the module lateral transfer system comprises at least one hydraulic piston.

9. The module of claim 1, wherein the module is configured for insertion into a processing chamber wall or through a processing chamber floor.

10. The module of claim 9, wherein the module and process chamber are configured such that there is a substantially automatic alignment of one or more power and process gas supplies upon insertion of the module into the processing chamber.

11. The module of claim 1, wherein the module is configured as a multi-functional cartridge that optionally comprises a system for rapid connection of cartridge components to processing chamber components.

12. The module of claim 11, wherein the cartridge components comprise a cartridge framework, a lateral transfer system and one or more process additive systems.

13. The module of claim 11, wherein the cartridge components comprise a connection plate configured for sealing connection to a shell of the processing chamber and wherein the connection plate optionally comprises a hot air hook up flange and wherein refractory is optionally provided between the module and the connection plate.

14. The module of claim 11, wherein the cartridge components further comprise one or more alignment guides.

15. The module of claim 1, further comprising one or more drive components wherein the drive components are selected from the group consisting of chain drive components, sprocket drive components, and rack and pinion drive components.
